(19) United States
(12) Patent Application Publication
(10) Pub. No.: US 2026/0290145 A1
(43) Pub. Date: Sep. 24, 2026

(54) INTELLIGENT SYSTEM GENERATING HEALTH INSIGHTS BASED ON MEDICATION EVENTS AND BIOMETRIC DATA

(71) Applicant: Sam Johnson, Largo, FL (US)

(72) Inventor: Sam Johnson, Largo, FL (US)

(21) Appl. No.: 19/684,599

(22) Filed: May 21, 2026

Related U.S. Application Data
(63) Continuation-in-part of application No. 19/049,905, filed on Feb. 10, 2025.
Application No. 19/049,905 is a continuation of application No. 18/143,834, filed on May 5, 2023, now Pat. No. 12,223,820.
Application No. 18/143,834 is a continuation of application No. 17/689,215, filed on Mar. 8, 2022, now Pat. No. 11,657,697.
Application No. 17/689,215 is a continuation of application No. 15/929,559, filed on May 9, 2020, now Pat. No. 11,276,295.
Application No. 15/929,559 is a continuation of application No. 16/374,547, filed on Apr. 3, 2019, now Pat. No. 10,650,660.

(51) Int. Cl. G08B 21/24; A61J 7/04; G06F 21/31; G08B 13/06; G08B 13/08; G08B 21/18; G08B 25/08

(52) U.S. Cl. CPC G08B 21/24; A61J 7/0427; A61J 7/049; G06F 21/31; G08B 13/06; G08B 13/08; G08B 21/18; G08B 25/08; A61J 2200/70

(57) ABSTRACT

An intelligent health system includes a sensor-enabled medication container associated with a patient configured to detect medication events associated with the medication container and output data regarding the medication events, one or more wearable devices configured to collect biometric data from the patient and output the biometric data, and a host system configured to receive the data regarding the medication events associated with the medication container, receive the biometric data from the one or more wearable devices, correlate the received biometric data and the data regarding the medication events, generate, based upon an analysis of the correlated biometric data and the data regarding the medical events, a health-related recommendation or alert, and transmit the recommendation or alert.

### CROSS-REFERENCE TO RELATED APPLICATIONS

This application is a continuation-in-part of U.S. application Ser. No. 19/049,905, filed Feb. 10, 2025, which is a continuation of U.S. application Ser. No. 18/143,834, filed May 5, 2023, now U.S. Pat. No. 12,223,820, which is a continuation of U.S. application Ser. No. 17/689,215, filed Mar. 8, 2022, now U.S. Pat. No. 11,657,697, which is a continuation of U.S. application Ser. No. 15/929,559, filed May 9, 2020, now U.S. Pat. No. 11,276,295, which is a continuation of U.S. application Ser. No. 16/374,547, filed Apr. 3, 2019, now U.S. Pat. No. 10,650,660. The above-referenced applications are incorporated herein by reference in their entirety.

### BACKGROUND

One of the cruelest jokes we have ever played on ourselves is the naming of the memory medicine Ginkgo Biloba. Not a smart marketing strategy either. Nonetheless, the product tends to sell and a reason for the sales may simply be that most of us are plagued and frustrated by memory failures. These symptoms manifest itself in trying to remember a person's name, an item that our spouse asked us to pick up at the grocery store, or even simply the reason that we got up off of the couch, walked all the way into another room in the house and then stood there wondering why. Most of these situations can be comically laughed off; however, there are situations where memory failures can be quite problematic or even catastrophic.

A perfect example of a situation in which the adverse effect of memory lapses can be realized is in the taking or administering of medication. Depending on the medication and the individual, failure to take medication can result in severe harm. In view of this, one can appreciate that it can be very important to remember to take or administer medication, and to do so in a timely manner. Thus, what is needed in the art is a mechanism that can remind or notify an individual that he or she must take or administer medication, and even when the medication must be taken or administered.

Another example of a situation in which the adverse effect of memory lapses can be realized is in remembering that you have already received or administered a medication. Such memory lapses can result in an overdose of a medication. In view of this, one can appreciate that it would be advantageous to have a device that keeps track of taken and/or administered dosages, notifies or alerts an individual attempting to take or administer an overdose and/or takes measures to help prevent overdosing.

Most medications that are prescribed to individuals, as well as animals, are provided in containers, such as pill bottles, bottles of serum, or pill pouches etc. The packaging for medication can conveniently operate as a dosage reminder/control gateway in that the person taking or administering the medication at a minimum, must approach the packaging to obtain the dosage. In view of this characteristic, there is a need in the art for a dosage reminder or overdose preventer mechanism that can be attached to, adhered to or otherwise be associated with the packaging.

Related to these needs in the art there are additional needs in the art with respect to determining if a container in general has been opened, moved, tampered with, etc., as well as providing historical data about such activity with the container and providing alerts regarding such activity. These needs in the art can arise in a variety of settings, and a few examples include detecting movement or opening of a liquor bottle, detecting opening of a liquor of gun cabinet, detect movement of a moisture testing apparatus, etc.

Therefore, there is a need in the art for a device that can be used to detect when a container, such as a medicine package or otherwise, has been moved, opened or otherwise tampered with, collecting and storing information about such activity, and reporting to or alerting a person or system of such activity.

### SUMMARY

Aspects of the invention comprise intelligent health systems and methods, such as which are capable of integrating and analyzing detected medicant container event data with biometric data of a patient.

In one embodiment, an intelligent health system comprises a sensor-enabled medication container associated with a patient configured to detect medication events associated with the medication container and output data regarding the medication events, one or more wearable devices configured to collect biometric data from the patient and output the biometric data, and a computing system including at least one processor and memory storing instructions that, when executed, cause the computing system to receive the data regarding the medication events associated with the medication container, receive the biometric data from the one or more wearable devices, correlate the received biometric data and the data regarding the medication events, generate, based upon an analysis of the correlated biometric data and the data regarding the medical events, a health-related recommendation or alert, and transmit the recommendation or alert.

In some embodiments, the step of correlating comprises temporally aligning the biometric data with the data regarding the medication events.

In some embodiments, the analysis of the correlated biometric data and the data regarding the medical event is performed by an AI engine which applies a machine-learning model that relates medication events to physiologic responses. The AI engine may be configured to generate a predictive representation of the patient's biometric medication-response, such as for comparison to predetermined ranges.

In some embodiments, the biometric data comprises one or more of: heart rate data, blood pressure data, blood oxygen data, blood glucose data, and temperature data, and the data regarding the medication events comprises at least one of: a detected opening of the medication container, a change in a mass of medication associated with the medication container, and a change in volume associated with the medication container.

In some embodiment, the transmitted alert may comprise a change in a dosage of medication associated with the medication container.

These and many other embodiments, as well as various features, aspects and functions of the various embodiments are more fully presented below.

### BRIEF DESCRIPTION OF THE DRAWINGS

FIG. 1 illustrates one embodiment of a system including at least one container having an associated activity monitor of the invention.

FIG. 2 illustrates one embodiment of a method of the present invention using a system such as that illustrated in FIG. 1.

FIGS. 3A-C illustrate graphical interfaces in accordance with the present invention.

### DETAILED DESCRIPTION OF EMBODIMENTS

The present disclosure, as well as features and aspects thereof, is directed towards an activity monitoring or detection device, apparatus, system and/or method that monitors or detects activity associated with a container. The activity monitoring device or system has particular utility to a medicant container, although it will be appreciated that the activity monitor presented in this disclosure may be used in a variety of settings and environments and may be used for a variety of purposes. Specific examples are illustrated and described within the disclosure to provide a general, overall and specific understanding of the various aspects, functions, operations and capabilities of the activity monitor but, such specific examples are provided as non-limiting examples.

Aspects of the disclosure relate to monitored medicant containers, such as medicant containers with one or more activity monitors or sensors, and systems for receiving information regarding detected event associated with such medicant container, for receiving biometric information from an associated patient, such as from a wearable device of the patient, and for analyzing such information, such as including temporally correlating biometric data with detected medicant device data, such as for predicting health events and generating health-related outputs, such as medicant dosage changes and alerts.

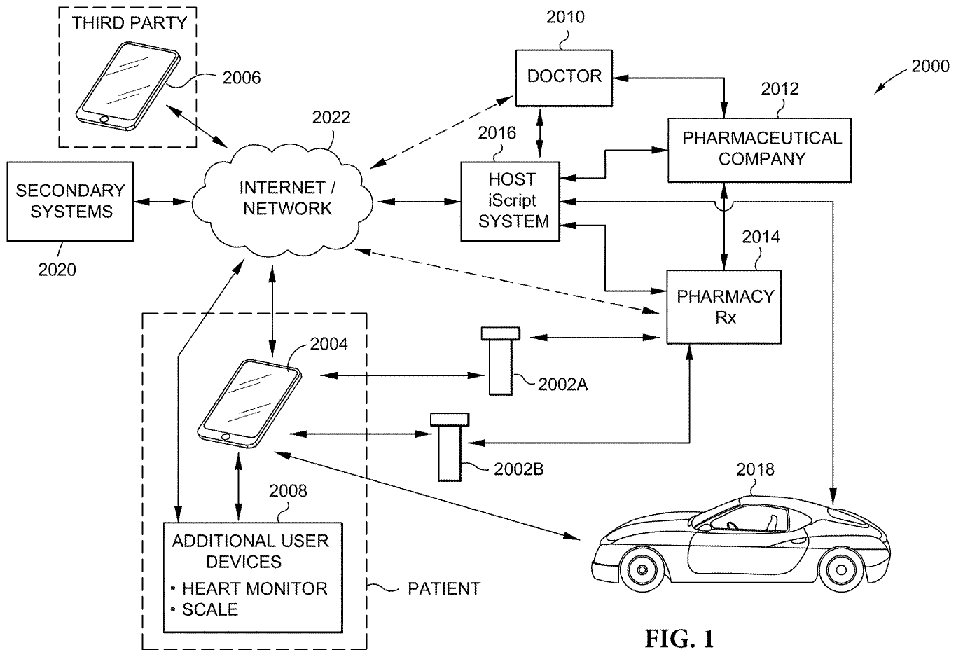

One aspect of the invention is a “smart” RX system. One embodiment of such a system 2000 is illustrated in FIG. 1. In one embodiment, the system 2000 includes one or more, such as many, medicant activity containers 2002. Such containers 2002 may comprise the containers which are described and illustrated in U.S. Pat. No. 12,223,820 to the inventor herein, the disclosure of which is incorporated in its entirety herein by reference. As detailed therein, such a container may be configured with one or more sensors or otherwise be configured to generate an output relating to an activity or event associated with the container. The output might be a sensed opening of the container, a detected or measured change in weight or volume of the container or the contents thereof, a sensed or detected movement of the container. Of course, such containers 2002 might comprise other types or configurations of containers 2002 now known or later developed. In one preferred embodiment, the containers 2002 are used to hold prescriptions and the system 2000 comprises a “smart” prescription system. As such, the containers 2002 (wherein FIG. 1 illustrates two such containers 2002 (A, B) may be referred to as prescription containers.

In one embodiment, the system 2000 may comprise, or various features or elements thereof may be configured to communicate or link to, one or more the following additional elements: 1) a patient device 2004; 2) a third party device 2006; 3) additional patient devices 2008; 4) a physician or doctor 2010; 5) a pharmaceutical company 2012; 6) a pharmacy/pharmacist 2014; 7) a host system 2016; 8) a vehicle 2018; 9) one or more secondary systems 2020; and 10) one or more communication links or networks 2022.

The patient's device 2004 may comprise, for example, wearables such as smart watch, a smart phone, PDA, laptop, tablet or the like. As described herein, such might comprise an Apple iPhone or the like. The patient device 2004 is preferably configured as a communication device (e.g. can transmit information to and/or receive information from, another device(s) or system(s)) and is capable of receiving input and providing an output, such as by displaying information on an associated display and/or providing an audio output or the like.

The third party device 2006 may comprise a similar device. Such a device might belong to a parent, child, friend or the like.

The host system 2016 may comprise a management system. The host system 2016 might comprise, for example, one or more servers which comprise one or more processors or controllers, at least one communication device or interface, a database or other data storage device, and one or more additional memory or data storage devices (such as separate from the database). In one or more embodiments, the processor(s) is configured to execute one or more instructions, such as in the form of machine readable code (i.e. “software”), to allow the server to perform various functionality, such as the functionality described herein. The software is preferably non-transitory, such as by being fixed in a tangible medium. For example, the software may be stored in the one or more memory devices. One or more of the memory devices may be read-only. In addition, the software may be stored on a removable medium in some embodiments. In general, the one or more memory devices are used as temporary storage. For example, the one or more memory devices may be random access memory or cache memory used to temporarily store some user information and/or instructions for execution by the at least one processor.

The software may comprise one or more modules or blocks of machine readable code. Each module may be configured to implement particular functionality when executed by the one or more processors, and the various modules may work together to provide overall integrated functionality. Of course, in certain embodiments, it is also possible for various of the functionality to be implemented as hardware, i.e. a processor or chip which is particularly designed to implement various of the functionality described herein.

In one embodiment, the host system 2016 server may include (or be linked communicatively at one or more times to) one or more input and/or output devices, such as a keyboard, mouse, touchscreen, video display or the like, whereby the processor may receive information from an operator or servicer of the server and/or output information thereto. This allows, for example, an operator of the server to interface with the server to upgrade, maintain, monitor, etc., it. In other embodiments, an operator might interface with the server via a separate workstation or other device.

In one embodiment, the processor and other elements of the host system 2016, such as the server, may be linked and thus communicate over one or more communication buses. In this manner, for example, the processor may read/receive software from the memory for execution, receive inputs and provide outputs to the various I/O devices, receive information from or output information to external devices via the communication interface, etc. The one or more communication devices or interfaces permit the server to communicate with external devices, networks, systems and the like. The server may communicate with those external devices or systems via one or more networks. The network(s) might comprise wired and/or wireless communication networks, may comprise LANs, WANs or be of other types. In one embodiment, the network may comprise or at least include the Internet.

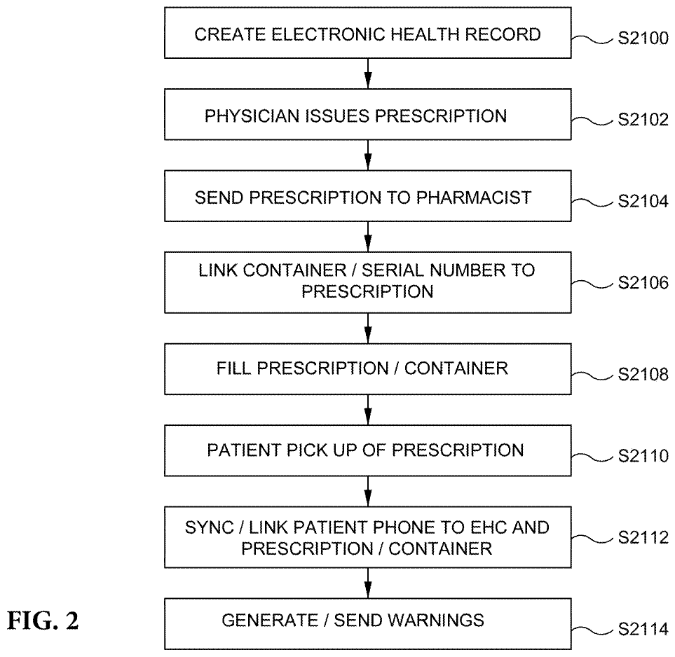

Aspects of the system 2000 will now be described with reference to methods of use thereof, including one embodiment of a method illustrated in FIG. 2. In one embodiment, a health record is created for a patient, as in step S2100. The health record is preferably an electronic health record and may comprise a data file which is stored at a memory or data storage device of (or connected to) the host system 2016. In one embodiment, the health record identifies a patient, such as via name, social security number and the like, and contains or links to additional information as detailed below.

In one embodiment, a patient may visit a physician 2010 (or other person or entity which can prescribe medications, etc.). The physician 2010 may check to see if the patient has an existing health record with the host system 2016 and, if not, may create the health record, such as by communicating with the host system 2016. In other embodiments, a patient may create a health record, such as by providing their name and other identification.

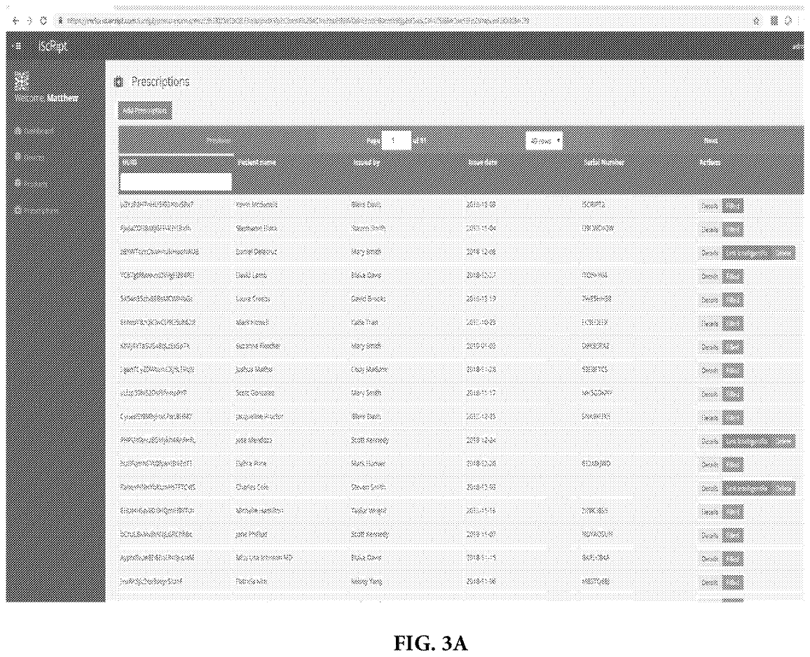

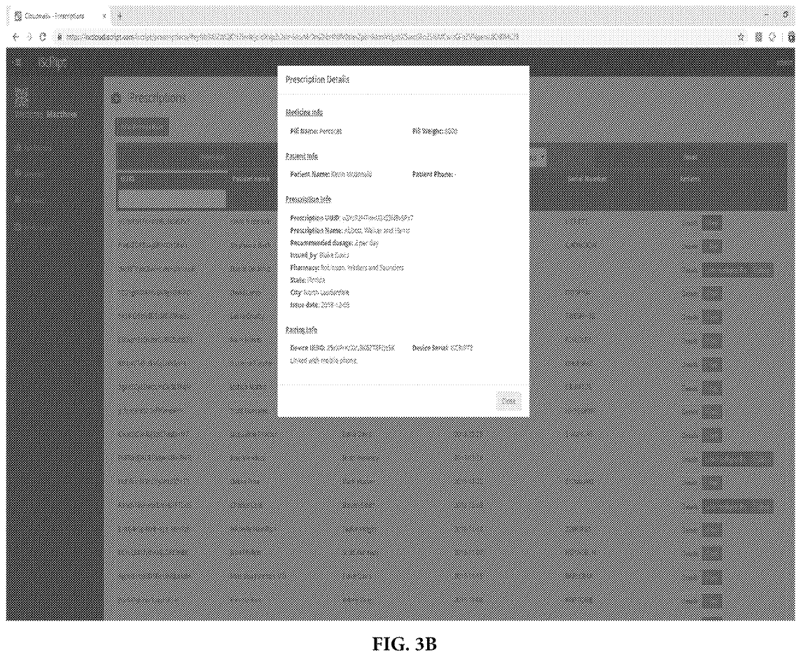

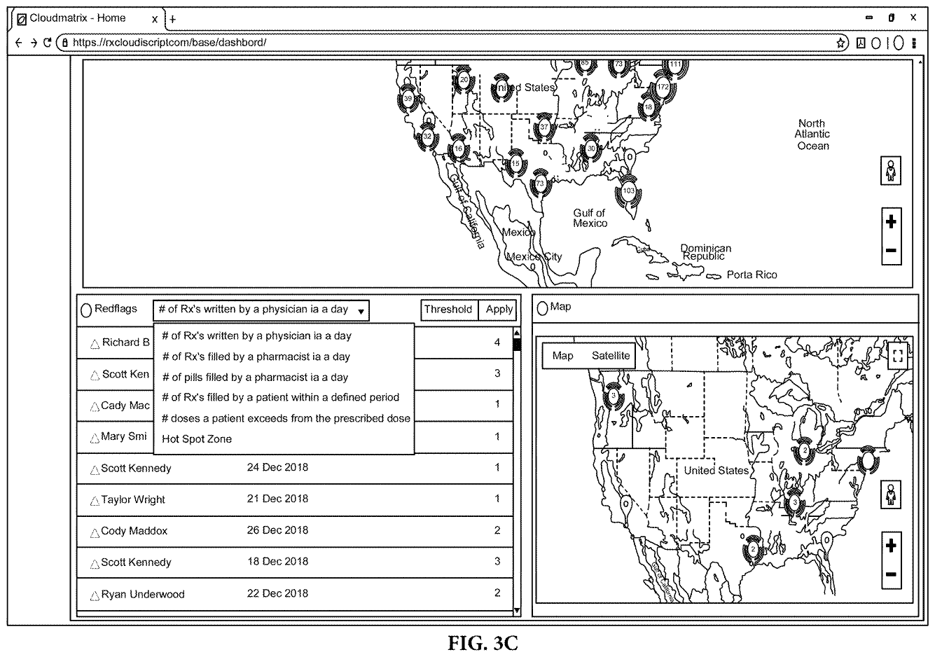

In a step S2102, the physician 2010 may issue a prescription for the patient. The patient may seek to have the prescription filled, such as at a pharmacy 2014, wherein the physician 2010 may transmit the prescription to the pharmacy 2014 for fulfillment (such as by transmitting it electronically to a computer at the pharmacy) or by having the patient drop off a printed version of the prescription with the pharmacy 2014, as at step S2104. In a preferred embodiment, the physician enters the prescription to the host system 2016, where that prescription is assigned an identifier, such as a UUID (universally unique identifier) and wherein the prescription is linked to the patient. FIG. 3A illustrates a graphical user interface which illustrates a list of UUID records, each of which includes the UUID, the associated patient name, the name of the issuing physician, the issue date of the prescription and other information, such as the container serial number and status, as described in detail below. As illustrated in FIG. 3B, the UUID record may contain additional information, such as complete details regarding the prescription (drug name, amount) and other data. These UUID records may be generated and stored/maintained by the host system 2016.

In one embodiment, the physician's 2010 issuance of the prescription may also be reported to one or more entities or systems, such as a health insurance secondary system 2020, the pharmaceutical company that makes or distributes the prescribed medication, and the host system 2016. For example, relative to an insurer, the issuance of the prescription and the use of the medication by the patient may be utilized relative to confirming the patient's health status, to process a claim, to ensure that the patient is not obtaining prescriptions and then potentially reselling them or the like. In one embodiment, such secondary reporting might be performed by the host system 2016.

In a step S2106, the pharmacist fills the prescription. In one embodiment, once the prescription is entered by the physician, it may be transmitted automatically to the pharmacist to be filled. In other embodiments, as noted, a patient might take the written prescription to the pharmacist and the pharmacist might look up the prescription in the host system 2016.

Preferably, when the pharmacist fills the prescription, they use a container 2002 of the present invention. The container 2002 preferably has identifying information associated therewith, such as a unique serial number. The serial number might comprise a unique address, such as a MAC address when the container 2002 has a communication interface, or might comprise a bar-coded identifier or other printed information or the like. The pharmacist preferably scans or otherwise inputs the serial number into the host system 2016 relative to the prescription record. For example, when the container 2002 has a communication interface which communicates a MAC address, the pharmacist might link the container 2002 communicatively with an interface which reads the MAC address (such as a WiFi or Bluetooth communication interface associated with the pharmacy's computer). The pharmacist might otherwise scan a barcode of the container 2002 or manually enter a serial number associated with the container. As illustrated in FIG. 3A, once the pharmacist as linked the serial number for the container 2002 to the prescription record, that serial number information is preferably updated in the record. Once this linking (of serial number to prescription) is done, the prescription record may also be updated to indicate an initial “fill” status, such as by causing a “Link” button of the record to be updated to a “Filled” button which is illuminated or illustrated in an orange color, such as illustrated in FIG. 3A.

Of course, at a step S2108, the pharmacist actually fills the prescription, such as by placing the appropriate medication in the container 2002. In some embodiments, such as where medication is pre-packaged, the process herein may simply be implemented relative to that pre-packaged prescription.

Once the prescription is ready, it is picked up by or delivered to the patient, as at step S2110. In one embodiment, when the patient picks up their prescription, their mobile phone is linked to the prescription. The patient might enter their mobile phone number into an interface (such as POS device or keypad) at the pharmacy, provide the number to a customer service representative who enters the number into the system, and/or may sync or link their mobile communication device via a communication interface. In this step, the patient's mobile phone number is preferably linked to the prescription record at the host system 2016, such as illustrated in FIG. 3B. Of course, if the patient has already provided a mobile phone number for one prescription, when another prescription is entered into the system for that same patient, their phone number might automatically be linked to that new prescription-at least as a default.

When the patient picks up their prescription, the prescription record is preferably updated to reflect that it was picked up, such as by changing the “Filled” status button to a green color. In a step S2112, once the prescription has been filled and picked up, other features may be implemented.

The patient's health record and/or the prescription record may include various information. In one embodiment, such information may comprise: 1) the identity of the patient; 2) contact information for the patient; 3) information regarding the patient (such as health data; other medications taken, etc.); 4) the prescribed medication (including amount prescribed, dosage, characteristics of the medication (liquid, pill, capsule, color, weight of each pill, shape/size of each pill, side effects, interactions); 5) dosing schedule, and/or other information. In one embodiment, information regarding the medication, such as pill count, weight, etc., might be obtained from an automated medication dispensing device or system which the pharmacy is using. That system or device might report information to the host system 2016. In one embodiment, a user of the system 2000 may be able to view individual prescription records, such as illustrated in FIG. 3A. Alternatively, a user might be able to view a patient's health record and all prescriptions which are associated with that patient.

In one or more embodiments, features may be implemented via the activity monitor associated with the container 2002 and/or the patient's device 2004 and/or the host system 2016. For example, as indicated above, the medication may have a dosing schedule. This dosing schedule may be associated with the prescription, such as by input by the pharmacist. The activity monitor associated with the container 2002 may provide one or more alerts when it is time for the patient to take their medication. In other embodiments, such an alert may alternatively be provided by, or additionally be provided by, the patient's device 2004. For example, information regarding the dosing schedule and various alerts may be downloaded from the host system 2016 to the patient's device 2004 (such as by interaction with an application or “App”) running on their device, or via communication between the container 2002 and the patient's device 2004.

In one embodiment, the reminder to take medication remains on the container 2002, device 2004 and/or system 2016 until the patient takes the medication (as determined by the container's activity monitor). As one example, the host system 2016 may generate and transmit a dosing schedule alert to the patient's device 2004 and the container 2002, thus triggering an alarm at each device. In one embodiment, these alarms can't be turned off by the patient except by the patient taking the medication, as determined by the container 2002. This prevents, for example, the patient from simply trying to turn off or clear the alarm from their device 2004 when they haven't yet taken their medication. As one example, a “take medication” alert might be displayed on the patient's device 2004. This window or alert might only be taken down after the container 2002 detects that the medication has been removed from the container (wherein the medication access which removes the alert might be transmitted from the container to the patient's device 2004 directly, such as when they are linked as described below, or might be transmitted from the container to the host system 2016 and the host system may then communicate with the patient's device).

A similar notification or alert might be provided to one or more third parties, such as family members. As indicated above, the patient's health record or a particular prescription record may store various information regarding the patient, including previous and new medications, dosing schedules, a history of events (taking of medications, missed dosages, etc., and contact information. The contact information may include the patient's contact information, such as their cell phone number, email address or the like, including for alerts, as well as information for third parties such as friends or families to with whom the patient desires to exchange information (such as the mobile phone number of a family member). In this configuration, when a dosing alert is provided to the patient, such an alert may also be provided to each designated third party. Such an alert might comprise a text message, email, voice message or the like, such as to indicate that “George's 8 am dosing of XYZ medication is due.” In one embodiment, the third party may also be provided with an alert when the patient takes their medication and/or further alerts if the system does not receive information that the patient took their medication in a designated time period.

As indicated herein, alerts and other information may be reported to a number of parties. As noted above, each time the patient accesses the container 2002, that access activity and any change in the amount of medication in the container 2002 may be collected by the container and then reported to the system 2016. Of course, a patient's failure to take their medication may also be reported. This and other information may be reported or be used to generate other reports which are reported. For example, the host system 2016 may report to the patient's physician whether the patient is taking their medication, if the amounts are being taken at the correct time and/or in the correct amount or the like. Also, as illustrated in FIG. 1, a patient might be prescribed more than one medication, including by different physicians, wherein the different medications are associated with different containers 2002,2002B. The host system 2016 may track the activities associated with both containers 2002A,2002B and may, for example, report to both physicians that the patient is taking both medications. This may be used by the physicians to see that their patient is taking more than one medication, including potentially one or more medications that were prescribed by other physicians, such as to ensure that the patient is being prescribed the correct dosages (such as in view of other medications they are taking) and/or reduce the risk of drug interaction. In one embodiment, as noted above, the host system 2016 may collect information regarding the various medications, such as from the pharmaceutical companies. This information may be used to generate alerts or warnings when the system detects that a patient has been prescribed medications which have interaction issues or may, in view of stored patient health information, create risks for the patient. As one example, the system 2016 might detect that a patient has been prescribed Medication A by Physician A, and that the patent is then later prescribed Medication B by Physician B, where Medications A and B have interaction issues. The system 2016 might send an alert to the patient's device 2004 advising them to contact their physician(s) immediately, such as before both medications are taken at the same time. Alternatively, such a warning or alert might be sent from the system 2016 to Physician A and Physician B so that they may directly address the issue.

Of course, when a physician detects that a patient is not taking their medication, is not taking the correct amount of their medication or is taking their medication at the wrong time(s) (such as reported by the activity monitor associated with the container 2002 to the host system 2016), the physician may contact the patient to determine why, to engage in a plan to ensure the patient does get back on schedule, etc. In the embodiment illustrated in FIG. 1, the medication events may be reported from the container 2002 to the host system 2016 for connection and reporting to the physician. In other embodiments, the patient could take the container 2002 to the physician and the physician could interrogate the container 2002, such as by syncing their computer or device to the activity monitor of the container 2002 to download event information directly.

In one embodiment, the activity monitor of the container 2002 may be configured to sync or pair with other devices. One such device may be the patient's device 2004. For example, using a Bluetooth communication interface, the patient's device and the container 2002 may see each other. The patient may be able to “accept link to container” via the container or their device to put them in a communication sync. In one embodiment, the patient may be required to enter a code into their device 2004 in order to link their device to the container 2002, thus preventing third parties from linking their devices to the container 2002 without authorization. As indicated herein, however, the container 2002 may link or sync with other devices, such as a third party's device (such as a friend, parent or relative), or even third party systems. For example, as noted herein, the container 2002 may link, either directly or indirectly (e.g. such as through the host system 2016) to physician's device or system, a pharmacy device or system, etc. In one embodiment, the container 2002 may link to a law enforcement system. In some instances, the linking or communication may be automatic and without any user authorization. For example, when a pharmacy issues a prescription for an opioid, the associated container 2002 may be configured to automatically link or report to a law enforcement device or network. In this manner, a law enforcement agency or the like might track movement of the prescription, use of the prescription and the like. Such may be useful, for example, for the law enforcement agency to determine that prescriptions are being issued and then moved to a particular location for resale, or that the user thereof is being issued large quantities of prescriptions and thus either abusing the drug or reselling the drug or the like.

Once the container 2002 is linked to the patient's device 2004, the activity monitor 2000 of the container may communicate with the patient's device 2004 and vice versa. For example, as noted above, the patient may be required to enter a PIN or code in order to unlock the activity monitor, clear an alarm or the like. In such a configuration, a prompt to enter the PIN or code might be displayed on the patient's device 2004. The patient may then enter the PIN or code into their device 2004 and the PIN or code may be transmitted to the container 2002.

One aspect of the invention is the ability to either limit access to the container and/or verify the user thereof. For example, the container 2002 (such as the activity monitor) may include one or more input devices such as buttons, a reader (such as for reading a fingerprint, retina, face, etc.) to determine the user of the container 2002, such as to verify that the patient is the one accessing the container 2002. As one example, the patient may provide a fingerprint which is stored in association with their account in the host system 2016. When the patient accesses the container 2002, they may provide their fingerprint and that print may be transmitted along with information regarding a dosage of medication taken at the same time. The print may be referenced to the stored fingerprint in order to confirm that it was the patient that accessed the container and not a third party. Of course, where the patient's device 2004 is linked to the container, the patient might provide the code, fingerprint or the like to their device 2004 (in such a configuration, the input device(s) may be eliminated from the container 2002, thus simplifying its configuration).

In one embodiment, one or more features of the container 2002 may be configured to determine when the container is being used and to thus activate the features of the container. The various features of the container 2002, including features such as a Bluetooth communications interface and the like, may all be battery powered. In order to conserve battery power, various features of the container 2002 may be turned off when the container is not in use. For example, a weight sensor, communications interface (at least a transmitter thereof) and/or other features might be turned off when the container 2002 is in a period of inactivity. This might be accomplished by a “sleep” mode where certain features of the container 2002 are turned off or rendered inactive. When container 2002 is active, those features may be turned on. For example, the processor of the container 2002 might determine that it is time for the user to take a dosage of medication. The processor might then generate the reminder and wake the communication interface in order to send the reminder to the user's device. As another example, the user might pick up the container 2002, input their fingerprint or PIN code, which action may be detected by the container 2002, then causing the container 2002 to wake up, such as to then determine if the user has removed the lid, taken medication or the like.

In some instances the container 2002, such as the activity monitor, may include a locking mechanism which prevents unauthorized opening thereof, such as by limiting removal of the cap. In such a configuration, the lock may not be unlocked unless the patient provides the required PIN, code, a matching fingerprint or the like.

In one embodiment, the system may be configured to determine where a patient is taking their medication. For example, the container 2002 (or the activity monitor) might include a GPS device or the like which is capable of determining a location of the container 2002 and then report it to the system. In another embodiment where the patient's device 2004 is linked to the container 2002, location information associated with the patient's device 2004 may be linked to information from the container 2002, thus attributing a location to that information. For example, a patient may utilize their device 2004 to enter a PIN as part of taking a dosage of medication. The patient may then access the container 2002. The container 2002 may then report that the medication was taken (and the amount, etc.), such as to the host system 2016. At the same time, the patient's device 2004 may report the location of the device and that location information may be coupled to the medication access information at the host 2016. In another embodiment, the container 2002 might transmit information regarding the medication event to the patient's device which then tags that information with location information and then transmits that combined information to the host system 2016. The container 2002 and/or the patient's device 2004 might provide other information as well, such as a time that the container 2002 is accessed (opened, closed, etc.), such as based upon a clock associated with the patient's device 2004. Of course, other information may be associated with information regarding the container 2002. As one example, information regarding the weather or the like might be obtained from the patient's device and might be transmitted along with container event information. In other embodiments, such information might be obtained separately and might be linked to container information. For example, a patient might access the container 2002 and take medication. That event might, along with GPS location information, be reported to the host system 2016. Knowing the location of the event, the host system 2016 might obtain secondary information such as weather at the designated location or other demographic information or the like and link it to the container event information. Then data mining might be utilized upon a database of such stored information. Such might reveal, for example, that when the outdoor temperatures are higher, medication compliance rates increase, or that certain medications are prescribed and taken in larger quantities in certain geographical areas or among a particular segment of the population.

The container 2002, the host system 2016 and/or the patient's device 2004 may communicate with other devices or systems. For example, as illustrated in FIG. 1, the container 2002, host system 2016 and/or patient's device 2004 may communicate with the patient's vehicle 2018, such as via a wireless communication interface. In one embodiment, the vehicle's control system may include, or the patient may be able to download a control application which controls or limits operation of the vehicle. As one example, a patient may take an evening dosage of medication. This may be reported from the container 2002 to the patient's device 2004. The patient may then seek to drive their vehicle. The patient's device 2004 may transmit information to the vehicle that limits or prevents operation of the vehicle, such as if the medication was taken within a designated period of time from when they attempt to operate the vehicle. Of course, such a feature may be enabled in various manners. For example, the patient's device 2004 may be configured to transmit a “do not operate” signal to the vehicle 2018 for a period of time after a medication dosage has been taken. In another embodiment, information regarding the medication dosage might be transmitted from the patient's device 2004 or the container 2002 to the vehicle's controller which then disables operation of the vehicle for a period of time from when the dosage was taken. As one example, the vehicle's controller might prevent the vehicle from being started within the time period. Of course, an alert might be provided to the patient, such as via their device 2004 or a display in the vehicle to the effect that vehicle operation is disabled or is disabled until a particular time.

As illustrated in FIG. 1, instead of such information coming from the patient's device 2004 or the container 2002, a vehicle disable instruction or information regarding a taken dosage might be transmitted from the host system 2016 to the vehicle.

In one embodiment, the container 2002, patient's device 2004 and/or host system 2016, might communicate directly with vehicle system components (such as an ignition system) via communications therewith through the vehicle's CAN BUS, or might communicate to the vehicle's controller via the CAN BUS, whereby the vehicle controller then implements the disabling functionality. In another embodiment, those devices or the system might communicate with a third party system which, in turn, is configured to communicate with the vehicle. For example, the host system 2016 might communicate with the General Motors ONSTAR® system, which in turn transmits designated instructions (such as a “disable” instruction) to the vehicle.

Yet another device that that the system 2000 might communicate with is an Alexa device by Amazon (or similar types of devices). Such a device may link to the host system 2016. A patient might, for example, ask Alexa “what time do I need to take my prescription”? The host system 2016 may (where the Alexa device is linked to the host system 2016 via an appropriate login or the like) look up the patient's record and associated information and then cause the Alexa device to indicate a response, such as “2 pills of Prescription X at 8 pm after a meal.”

One aspect of the system 2000 is the ability to manage and share information associated with container events. For example, as described above, an alert that a medication dosage should be taken may be provided to third parties such as friends or family. Likewise, information that the patient has taken medication, has missed a dosage, has taken the wrong dosage or the like may be reported to friends, family, a physician or the like. In one embodiment, information regarding medication prescribed to the patient and taken by the patient may be reported to a pharmaceutical company 2012. This may aid the company in tracking usage of their drugs, potential future demand and the like. In other instances, the medication might comprise a new drug which is on a trial, wherein it is important for the company to carefully track the usage of the medication, amounts taken and the like to confirm the efficacy of the drug and the like.

Such information might also be shared with other systems 2020. As one example, information regarding prescribed medication and/or amounts of medication taken by the patient may be transmitted to a governmental database (or to an agency, such as law enforcement, etc.) This might be used, for example, to track the usage of dangerous drugs, such as opioids. As one example, the host system 2016 might track a first prescription obtained by the patient from a first physician for a painkiller and then a second prescription obtained by the patient from a second physician for the same or a different painkiller. The host system 2016 might transmit that information to a governmental database which can then flag that the patient is potentially abusing those painkillers by obtaining separate prescriptions. Such a system might also flag excess usage of medications. For example, a patient might obtain a valid prescription for a painkiller but then take two times the prescribed dosage. In that event, the activity monitor information may be transmitted to the host system 2016 which then reports the dosages to the governmental database. Evaluation of that data may reveal that the patient is taking an excess dosage. In those events, the information may be used to provide a warning to the patient, to prevent further prescriptions of similar medication and the like.

As another example, information regarding medications taken by the patient might be shared with emergency medical personnel, such as first responders or ER personnel. This information might comprise, for example, the medication being taken by the patient and the last time the medication was taken. Such information may be used in diagnosing the patient's condition or be considered in a treatment strategy, such as to avoid drug interaction.

As another aspect of the invention, use of the containers and/or system of the invention (such as containers 2002 and system 2000) may allow for the implementation of certain benefits, such as discounts. As noted above, one problem with existing methods of distributing medication is that patients may not take their medication. This may result in continued or new health issues. As one aspect of the invention, for example, a health insurance company might offer its insureds a discount if they use the containers of the present invention and the insured takes their medication as prescribed (as confirmed by the system). For example, relative to the system 2000 illustrated in FIG. 1, one of the secondary entities might comprise an insurance company. The insurance company might have a system which is communicatively linked to the iScript Host system 2016, whereby the insurance company can receive information regarding prescriptions which are provided to their insured and receive information regarding use of the containers 2000, including whether the insured are taking their medication. The insurance company might offer a discount to an insured to who takes their medication, such as by communicating a reduced price for the medication or a discount or offset to the pharmacy 2014 (e.g. whereby the insured pays less for their prescription) or might offer a rebate or the like to the insured (for example, the insured might pay regular price for their prescription but might then be provided a rebate if the insurance company determines that the insured took the medication as prescribed). Such discounts, rebates or the like might be monetary rebates which are paid to the insured by check, credit to an account (bank account, debit or credit card or the like). In some embodiments, the amount of the discount or the rebate might be dependent on a number of factors such as the percentage of time that the insured takes their medication or takes their medication within a required time window or the like, wherein the discount or rebate may be higher when full compliance is confirmed and may be less when the insured is only partially compliant (such as when the insured takes medication late or misses taking their medication entirely). In other cases, the insured might be penalized if the insurance company determines that the insured is non-compliant. For example, if an insured is prescribed medication and the system 2000 confirms that the insured did not take the medication, the insurance company might warn the insured that their failure to take the medication may result in a loss of coverage or increase in premium for the insurance.

Similarly, discounts or rebates might be provided in other contexts and/or the information might be used in other manners. For example, an auto insurer might also provide discounts or rebates for medication compliance as determined by the containers and/or system. A life or disability insurer might offer discounts or rebates as well. As another example, medication compliance as determined by the containers/system of the invention might be used in the determination of a person's credit score (such as where a person's credit score or rating is increased based upon a high level of medication compliance and/or reduced based upon non-or low-level compliance. Employers might also use the information, such as in a hiring process or determining continued eligibility for a job. As one example, a person who is a driver, who operates machinery (construction, train engineer, airline pilot) or the like might have their job depend upon compliance with taking their medication as determined by the containers/system of the invention. Again, as one benefit of the system, containers are configured to determine medication compliance, information is collected from the containers and can be reported to secondary users of the information and can be used for various beneficial secondary purposes.

As one aspect of the disclosure, the method and system may not only be configured to receive primary patient activity information in the form of medicant container activity information, but secondary information-e.g. information other than patient medicant container activity information. Such secondary information may comprise, but is not limited to, patient-related information including biometric or physiological condition data, patient event-related data and environmental condition or other data, as well as information relating to third parties (such as other patients or individuals). As detailed below, such collective information may be used (including in conjunction with the collected medicant container activity information) to train one or more predictive AI models and to generate, such as via use of an AI engine using the trained model(s), one or more patient-related outputs. The patient outputs may comprise, for example, modified prescription data including modified prescription dosages and schedules, replaced the existing medication, as well as alerts, notifications and/or feedback.

As one example, patient biometric (whether physiological or behavioral) data may be collected. This information may be obtained from various sources, including patient devices 2004, 2008 and third-party systems or sources. For example, the patient's heart rate, weight, temperature blood pressure, blood sugar, blood oxygen level, breath rate and/or other information might be collected, such as directly from the patient's devices 2004,2008 (such as in real time) or from third-party systems (for example, a patient who visits a doctor's office might have their blood pressure, pulse and weight measure and input into a physical system 2010). As examples, such information might be collected from one or more devices worn by the patient (whether from the device directly or a related system), or from specialized devices, detectors or sensors.

As another example, patient event-related data may comprise information regarding a location of the patient, movement of the patient, activity information of the patient (the patient went on a walk, hike, or bike ride, swam or engaged in weight-lifting, slept or other activities) or other information, or information derived therefrom. For example, instead of or in addition to obtaining information about a particular exercise that the patient engaged in, the information may comprise derived or secondary information, such as a calculated number of calories expended by the patient during a particular time period, etc. Other secondary information might include information about dietary intake of the patient, such as particular foods consumed at particular times, amounts of food consumed by a patient (such as information regarding the caloric value thereof or other attributes such as carbohydrate or sugar content thereof, etc.) Other derived information might also comprise, for example, a sleep score, a stress score or other indicators.

Collected secondary information might also comprise environmental or other data which relates to the patient, such as the environmental temperature at the location of the patient, the altitude, humidity, or other information. Relative to the system 2000 illustrated in FIG. 1, such information might, as detailed above, be received by the host system 2016, such as from the patient's devices 2004,2008, one or more third party or other systems, or even third-party devices. For example, secondary information might be collected or received from third party devices, such as devices belonging to other patients.

In one embodiment the secondary information may be utilized, either alone or in conjunction with medicant container activity information, in a number of ways and for a number of purposes. As one aspect of the invention, such information may be used to train a predictive AI model and to generate, such as by applying the trained model to certain primary and/or secondary information, patient-related outputs. As described below, such outputs may comprise outputs or instructions which are provided to the patient, a medicant container of the patient, or a third party such as the patient's doctor, a third-party system or a relative or friend of the patient.

In one embodiment, the system 2000, such as the host system 2016 may implement such functionality (directly or indirectly). The host system 2016 may comprise a server which comprises one or more processors or controllers, at least one communication device or interface, a database or other data storage device, and one or more additional memory or data storage devices (such as separate from the database). In one or more embodiments, the processor(s) is configured to execute one or more instructions, such as in the form of machine-readable code (i.e. “software”), to allow the server to perform various functions. The software is preferably non-transitory, such as by being fixed in a tangible medium. For example, the software may be stored in the one or more memory devices. One or more of the memory devices may be read-only. In addition, the software may be stored on a removable medium in some embodiments. In general, the one or more memory devices are used as temporary storage. For example, the one or more memory devices may be random access memory or cache memory used to temporarily store some user information and/or instructions for execution by the at least one processor.

The software may comprise one or more modules or blocks of machine-readable code. Each module may be configured to implement particular functionality when executed by the one or more processors, and the various modules may work together to provide overall integrated functionality. Of course, in certain embodiments, it is also possible for various of the functionality to be implemented as hardware, i.e. a processor or chip which is particularly designed to implement various of the functionality described herein incorporated as a secondary processor to the medicant container.

The host system 2016 may implement, either directly via the server thereof or by communication with one or more other devices or systems, an AI engine 2017 which utilizes the trained model to implement a model-driven medicant monitoring and predictive prescription tool. The AI engine 2017 might thus be implemented on the server of the host system 2016, or might be implemented relative to, or interfacing with, a remote engine, such as a third-party AI engine (such as but not limited to OpenAI, Google Gemini, IBM Watson, ChatGPT, Claude or others). In some embodiments, the AI engine may be general, but in others it might be specific, such as being trained using information which relates to the use and analysis of the information described herein for the purposes described herein.

In one embodiment, the primary patient information and the secondary information is used to train a machine-learning model. The training may include one or more of: a) correlating medication events (such as the indicated dosing of a particular prescription in a particular dosage at a particular time from the medicant container activity information of a patient) with biometric changes, b) correlating medication events and secondary events such as the consumption of particular foods or a patient's engagement in one or more activities, with biometric changes, c) correlating modifications to medication events (such as reduced dosages or changed dosages times) with biometric changes, and d) correlating modifications to medication events to prescription compliance (e.g. changing a dosage time changes the compliance rate of the patient in taking their medication), etc.

In one embodiment, correlation may comprise or include temporal correlation, such as by using temporal windowing. For example, some of the biometric data may be correlated to specific medication event. The temporal correlation, including the size of the time window, may depend on and vary based upon factors like the medication at issue (some medications are faster and others are slower to act, for example), the particular biometric data, etc. In some embodiment, received medication event and/or biometric data may include time information, such as when the data was generated/or transmitted to the host system 2016. In other embodiments, the host system 2016 might time stamp the data. In some embodiments, the received medication event and biometric data may be stored in one or more data storage or memory devices associated with the host system 2016 and/or correlated data might be stored (such as in a correlated data set format). In some embodiments, determined reactions, interactions or other events may be determined and extracted, such as for storage in a data table and for use by the AI engine. For example, a temporally aligned high heart rate change after a medication event may be extracted and be used to predict potentially heart rate changes in response to similar dosing of the same medication in the future. Such information may be correlated to a single patient or across a wider group of patients or subjects.

In a preferred embodiment, feedback information (such as in the form of detected changes in biometric conditions or medicant compliance) may be used to further train the model, such as to modify predicted responses.

In some embodiments, using the trained model (including associated stored data), the AI engine may generate health predictions based upon detected primary and/or secondary patient information. For example, the AI engine may predict that a particular medication dosage at a particular time will result in a particular biometric change to the patient. This information may be used to send an alert or other output, as noted below.

In some embodiments, the AI engine may be configured to evaluate the primary and/or secondary patient information, or predicted outcomes, against desired or predetermined ranges. For example, the AI engine may determine that a predicted outcome of a particular medication dosage (such as at a particular time, including in relation to current biometric information of the patient) is likely to cause one or more of the patient's biometrics to go outside of a desired range (e.g. a very high heartrate, high blood sugar level, etc.), and the AI engine may thus generate an output suggestion a change in the medication dosing, a changing in the time of the dosing or the like.

In one embodiment, the primary patient information in the form of medicant container activity information is analyzed in conjunction with the secondary information described above to predictively modify a patient's prescription/prescription instructions, such as using the trained machine-learning model. This may comprise the host system 2016 receiving and storing the primary and secondary information in one or more data sets (such as in relation to designated patients or patient accounts) and/or accessing data from third parties or third party systems for use by the AI engine 2017. For example, in some embodiments, data pertaining to an individual patient may be stored in patient accounts associated with the host system 2016. However, other information, such as pertaining to individuals who may not be patients within the system (such as patients or individuals associated with other systems) might be accessed by the host system 2016 such as in a manner in which personal identifiable information or PII is not provided or transferred). The AI engine 2017 may use the trained model to access or utilize data from the one or more data sets or other sources (including, as applicable, filtering the data in the data sets for particular data, such as limited by type, time, etc.) and use the trained model to generate, using the selected data, one or more outputs.

Examples of such include, but are not limited to:

Use of such information to predict a drug interaction that is novel to a patient set between two or more prescriptions or one or more drugs and food or other medications (such as over-the-counter medications taken by the patient) that suggest modification of the patient's prescription to discontinue at least one of the drug or reduce or increase the dosage thereof or to change a timing of one or more prescription dosages around the patients captured activites. For example, secondary food ingestion information might be identified by the AI engine 2017 (such as the ingestion of a grapefruit at breakfast) and used by the AI engine 2017 to modify a patient's statin prescription to either reduce or increase the dosage thereof or change the timing of the dosage, such as to a later time. Such a generated output may be transmitted to the patient and/or a third party. For example, the host system 2020 might receive the output of the AI engine 2017 and cause the user's device 2004 (such as via a text message or via an application running on the device) to display a message “Today reduce dosage of prescription X to 1 tablet” or the like.

As indicated, the AI engine 2017 preferably uses medicant container activity information in the predictive analysis. For example, the AI engine 2017 may use information regarding past or current prescription dosages and times (as indicated by the medicant container activity information) to make predictive changes to later dosages and times. As examples, detection of certain biometric changes close in time to the detection of a patient taking a dosage (as indicated by received medicant container activity information) may cause the AI engine 2017 to predict future side effects and make modifications to the prescription, such as changing a prescription dosage time from late evening to early morning after the ingestion of food.

As one aspect of the invention, the AI engine 2017 may use the primary and secondary information to infer relationships of events and outcomes and generate risk analysis thereof, both as to individual patients and larger groups. For example, in analyzing the biometrics of a particular patient in relation to medicant container activity, the AI engine 2017 may predict a high risk of a side effect as to that patient if certain biometrics of the patient change regularly in associate with detected medicant container activity (e.g. a high heart rate after each detected dosage), even when such data does not appear relative to other patients. On the other hand, information about individual patients may, particularly in the absence of larger group information, be used to infer a probability that other patients may experience a similar reaction to a drug (or drug and secondary event such as a particular activity, food, etc.). In this manner, the AI engine 2017 might modify the prescription of a patient proactively. For example, the AI engine 2017 may infer that there is a probability that a patient who has just been prescribed a certain drug will have an interaction with a designated food, based upon actual indications of such from third parties, such as third parties having similar biometric indicators. In such an event, the AI engine 2017 may predictively modify the prescription of the patient based upon the patient's ingestion of the designated food, such as by reducing the next dosage thereof in order to reduce the probability of interaction.

As one aspect of the disclosure, the AI engine 2017 may generate a health state prediction for a patient based upon primary patient information and secondary information, including based upon an outputted modification. For example, the AI engine 2017 may predict that an outputted lower prescription dosage should result in a determined maximum heart rate increase. The actual heart rate of the patient may be monitored and analyzed by the AI engine 2017. In the event the patient's heart rate increases beyond the predicted increased value, the machine-learning model may be modified and a modified prescription or other output, such as an alert, may be provided. For example, such an alert might indicate to the patient that their out-of-range conditions dictate that they should take certain steps (drink fluid, rest, see a doctor).

As indicated herein, the output of the AI engine 2017 may be transformed into various secondary outputs, actions or events, such as by the host system 2016 or otherwise. For example, a modified prescription dosage or schedule which is output by the AI engine 2017 may be transformed into a message which is transmitted from the host system 2016 to the patient's device 2004. The AI engine 2017 output might also be used to generate other alerts or notifications, such as general health alerts which are transmitted to the patient or designated third parties (for example, upon detecting a biometric indicator of alcohol consumption by a patient taking a particular drug, the host system 2016 might cause the patient's device to display an message such as “As a reminder, while taking prescription X, do not drink alcohol”). Other messages, alerts or the like might be sent to third parties, such as the patient's doctor. As another example, the AI engine 2017 output might be used to generate and output control instructions. For example, upon detecting the ingestion of certain food by a patient, the host system 2016 might be configured to output an instruction to a medicant container locking mechanism or controller thereof, to prevent opening of the medicant container for a designated period time to prevent an accidental interaction. As another example, upon detection of a patient taking a medication, the AI engine 2017 might utilize that information in conjunction with the patient's weight or the like to output a vehicle control lock instruction to prevent the patient from operating the vehicle for a determined period of time. As also indicated above, such as output might be provided for various other purposes, such as for generating rewards for prescription compliance, etc.

In the description above, particular embodiments of communication or interaction between devices and systems have been described. It will be appreciated that similar functionality may be implemented by other configurations of devices and systems communicating with one another. For example, a container 2002 might transmit information to a patient's device 2004 which then transmits information to the host system 2016. In other embodiments, however, the container 2002 might transmit information directly to the host system 2016. Further, instead of the host system 2016 forwarding information from the container 2002 to other systems or devices, the container 2002 might transmit information directly to those systems or devices. As one example, the container 2002 might comprise a “IOT” or Internet enabled device. The container 2002 might thus communicate over the Internet to other systems and/or devices, such as by connecting to a wireless access point or router at the patient's home, office, etc.

As indicated herein, the host system 2016 (or another device or system in communication therewith) may store various information relating to the container, prescription, patient and the like. This information may be mined in various manners. In some embodiments, a user of the system or the AI engine 2017 may run queries or otherwise mine the data for information. For example, a user might run a search on the data stored at the host system 2016 to determine such things as “all prescriptions written for Drug A during the last 60 days”, “all prescriptions written by Physician A”, “all prescriptions prescribed to Patient A”, “all prescriptions for Drug A issued in State A,”, etc. In other words, data might be collected regarding “who”, “what”, “where”, and/or “when” the prescription was prescribed, filled or issued, and utilized, and that data may similarly be mined for individual criteria or combinations thereof.

Also as illustrated in FIG. 3C, the host system 2016 might be configured to automatically monitor the data and generate alerts, warnings, reports or the like, such based upon “red flag” criteria. As illustrated, the host system 2016 (including the AI engine 2017) might generate graphical alerts when red flag criteria are met. For example, the host system 2016 might be configured to monitor for a particular level of Opioid prescriptions to a single patient. If the one or more criteria are met, a red flag alert might be generated, such as by being displayed on a map which shows the location of the user. As another example, the system might be configured to display the locations (such as on a map) of all physicians that have prescribed more than a certain number of Opioid prescriptions. Of course, as indicated herein, as a result of monitoring of this data, similar alerts might be provided directly to patients, family members of patients, physician, law enforcement, pharmacists, pharmaceutical companies and the like.

It will be appreciated the “physician”, “pharmaceutical company” and the like may not only comprise persons or entities, but may comprise computing devices or systems which they operate or use, such as servers, computers, communication devices and the like. Those systems or devices may also comprise one or more databases of information, accounts and the like.

In one embodiment, aspects of the invention may be implemented by an application which is installed on the patient's device 2004 for execution by the processor of the device. Such an application might, for example, be downloaded by the patient to their device. In other embodiments, aspects of the invention might be implemented as a web-based application via a web browser running on the patient's device, which web browser communicates with the host system 2016, such as a web server thereof.

The present invention solves a number of problems and has a number of advantages. A tremendous number of different wearable devices exist which collect and attempt to track one or more biometrics of the wearer, such as to provide health information. These wearables, however, simply detect the wearer's biometrics and are not fully capable of determining the causes of changes in biometrics or predicting changes in biometrics.

In this regard, these wearable and associated tracking systems are missing the largest input variable to a wearer's biometrics: medications and medication events. Currently, approximately 5 billion prescription containers are dispensed to patients each year. However, there is currently no system or method which permits tracking of those medications, including the activities associated with those medication containers. There is thus also no way to integrate information about medication events to biometric data collected by wearables. Lastly, the first two problems prevent the correlation of biometric changes to medication events as to individual patients or across a large group of patients, and the use of such correlated information to predict outcomes and problems and generate medication or other health-related outputs or alerts. The present invention solves those problems in the manner noted above.

The present invention solves a number of technical problems, including by integrating medicant containers having associated sensors or detectors which are capable of generating an output associated with a detected medication event, with biometric data which is output from one or more patient wearable or other devices which are used to collect such information, and correlates that information, such as temporally. Moreover, the present system does not merely log medicant or biometric data, but trains learned and predictive models using such data in order to create a model which is capable of analyzing such medicant and biometric data to generate health-related or alert outputs, as detailed above.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In this application the words “unit” and “module” are used interchangeably. Anything designated as a unit or module may be a stand-alone unit or a specialized module. A unit or a module may be modular or have modular aspects allowing it to be easily removed and replaced with another similar unit or module. Each unit or module may be any one of, or any combination of, software, hardware, and/or firmware.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. An intelligent health system comprising:
a sensor-enabled medication container associated with a patient configured to detect medication events associated with the medication container and output data regarding said medication events;
one or more wearable devices configured to collect biometric data from the patient and output said biometric data;
and
a computing system including at least one processor and memory storing instructions that, when executed, cause the computing system to:
receive said data regarding said medication events associated with said medication container;
receive said biometric data from the one or more wearable devices;
correlate said received biometric data and said data regarding said medication events;
generate, based upon an analysis of said correlated biometric data and said data regarding said medical events, a health-related recommendation or alert; and
transmit said recommendation or alert.

2. The intelligent health system in accordance with claim 1, wherein said step of correlating comprises temporally aligning said biometric data with said data regarding said medication events.

3. The intelligent health system in accordance with claim 1, wherein said analysis of said correlated biometric data and said data regarding said medical event is performed by an AI engine which applies a machine-learning model that relates medication events to physiologic responses.

4. The intelligent health system in accordance with claim 3, wherein said AI engine is implemented by said least one processor.

5. The intelligent health system in accordance with claim 4, wherein said AI engine is further configured to generate a predictive representation of the patient's biometric medication-response.

6. The intelligent health system in accordance with claim 5, wherein said generated health-related recommendation or alert is generated using said predictive representation.

7. The intelligent health system in accordance with claim 5, wherein the predictive representation includes a personalized drug-response curve for the subject.

8. The intelligent health system in accordance with claim 3, wherein the machine-learning model comprises a reinforcement learning model that updates based on biometric data which is correlated to said data regarding said medication events.

9. The intelligent health system in accordance with claim 1, wherein the computing system is further configured to generate real or near-real-time biometric response predictions based upon received data regarding said medication events.

10. The intelligent health system in accordance with claim 9, wherein the computing system is further configured to compare received biometric data to said predicted biometric response.

11. The intelligent health system in accordance with claim 9, wherein the computing system is configured to output an alert when the predicted biometric response deviates from a predetermined range.

12. The intelligent health system in accordance with claim 1, wherein said biometric data comprises one or more of: heart rate data, blood pressure data, blood oxygen data, blood glucose data, and temperature data.

13. The intelligent health system in accordance with claim 1, wherein said health-related recommendation comprises a change in a dosage of medication associated with said medication container.

14. The intelligent health system in accordance with claim 1, wherein said data regarding said medication events comprises at least one of: a detected opening of said medication container, a change in a mass of medication associated with said container, and a change in volume associated with said medication container.

15. A method of implementing an intelligent health system comprising the steps of:
a) receiving, at a host computing system comprising at least one processor and a memory storing instructions that are executable by said at least one processor, biometric data from one or more wearable devices worn by a subject;
b) receiving, at said host system, information regarding a detected medication event via a sensor-enabled medication container;
c) generating, via an AI engine which applies a machine-learning model to the detected medication event and biometric data, a predicted near-term health state for the subject; and
e) issuing an alert or recommendation when the predicted health state indicates risk or deviation from a desired range.

16. The method in accordance with claim 15, wherein the recommendation includes a suggested modification to a timing, dosage, or adherence behavior of a medication associated with said medication container.

17. The method in accordance with claim 15, further comprising the step of temporally aligning one or more of said biometric data with one or more of said detected medication events.

18. The method in accordance with claim 15, wherein said alert or recommendation is transmitted to an application running on a mobile communication device of said subject.

19. The method in accordance with claim 15, wherein said AI engine comprises an interference engine.

20. The method in accordance with claim 15, wherein said machine-learning model is trained on biometric response to medication event data associated with multiple subjects.
